(19) United States
(12) Patent Application Publication
(10) Pub. No.: US 2009/0010640 A1
(43) Pub. Date: Jan. 8, 2009

(54) AUDIO/VIDEO SIGNAL REPEATER

(76) Inventor: HOW-CHIN LI, Chung Ho City (TW)

Correspondence Address: Connolly Bove Lodge & Hutz, LLP, P.O.Box 2207, Wilmington, DE, 19899-2207, US

(21) Appl. No.: 11/772,847

(22) Filed: Jul. 3, 2007

(51) Int. Cl. H04J 14/00

(52) U.S. Cl. 398/4

(57) ABSTRACT

An AV signal repeater includes a casing having multiple opening defined therein. A printed circuit board (PCB) is secured in the casing. The PCB has at least one signal connector and at least one terminal electrically mounted thereon. Each of the signal connector and the terminal is partially received in a corresponding one of the multiple openings. A signal transmission unit is electrically disposed on the PCB and electrically connected to the signal connector and the terminal for transmitting AV signal.

### BACKGROUND OF THE INVENTION

1. Field of the Invention

The present invention relates to a repeater, and more particularly to an audio/video (AV) signal repeater.

2. Description of Related Art

According to the developmental technology, the requirement of AV product is greatly raised, such as the computer, monitor, television and radio communication. In addition, the computer, the monitors, the televisions and the radio communication are usually in different room or area. To connect two computers for transmission AV signal or information, the internet is most constantly used. A switch box is used when a monitor corresponds to multiple computers or a computer corresponds to multiple monitors. The switch box, the computers and the monitors need multiple cables to connect one another. As a result, the multiple cables will occupy the floor of the wall. A man may kick cables when walkover the cables and cut off the connection among the switch box, the computers or the monitors.

The present invention has arisen to mitigate and/or obviate the disadvantages of the conventional among the switch box, the computers and the monitors.

### SUMMARY OF THE INVENTION

The main objective of the present invention is to provide an improved AV signal repeater that can prevent the AV cable from occupying the wall and the floor.

To achieve the objective, the AV signal repeater in accordance with the present invention comprises a casing having multiple opening defined therein. A printed circuit board (PCB) is secured in the casing. The PCB has at least one signal connector and at least one terminal electrically mounted thereon. Each of the signal connector and the terminal is partially received in a corresponding one of the multiple openings. A signal transmission unit is electrically disposed on the PCB and electrically connected to the signal connector and the terminal for transmitting AV signal. The AV signal repeater of the present invention is provided to be mounted to a distribution box that is previously embedded in a wall. The at least one AV terminal is electrically connected to AV cables in the distribution box. Consequently, the AV signals can be transmitted to another AV signal repeater in another room, via the transmission cable, the signal connector and the AV cable that is previously embedded in the wall. The AV cable is previously embedded in the wall such that the floor and the wall will not be occupied by the AV cable and the AV signals can be shared.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an audio/video (AV) signal repeater in accordance with the present invention;

FIG. 2 is an exploded perspective view of the AV signal repeater in FIG. 1;

FIG. 3 is a block chart of the AV signal repeater in FIG. 1;

FIG. 4 is an assembled chart of the AV signal repeater in FIG. 1;

FIG. 5 is a schematic view of the AV signal repeater in FIG. 1;

FIG. 6 is a perspective view of a second embodiment of the AV signal repeater in accordance with the present invention;

FIG. 7 is an exploded perspective view of the AV signal repeater in FIG. 6;

FIG. 8 is a schematic view of the AV signal repeater in FIG. 6;

FIG. 9 is a schematic view of a third embodiment of the AV signal repeater in accordance with the present invention; and

FIG. 10 is a block chart of the AV signal repeater in FIG. 9.

### DETAILED DESCRIPTION OF THE INVENTION

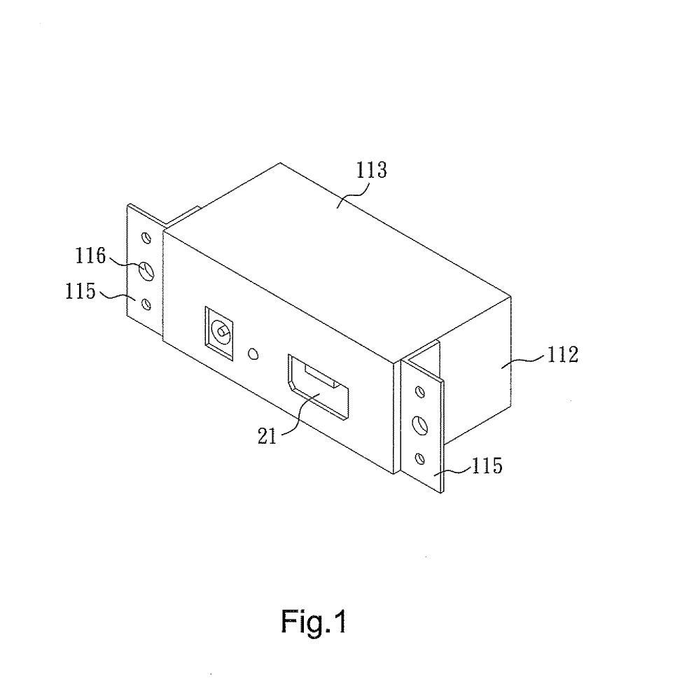

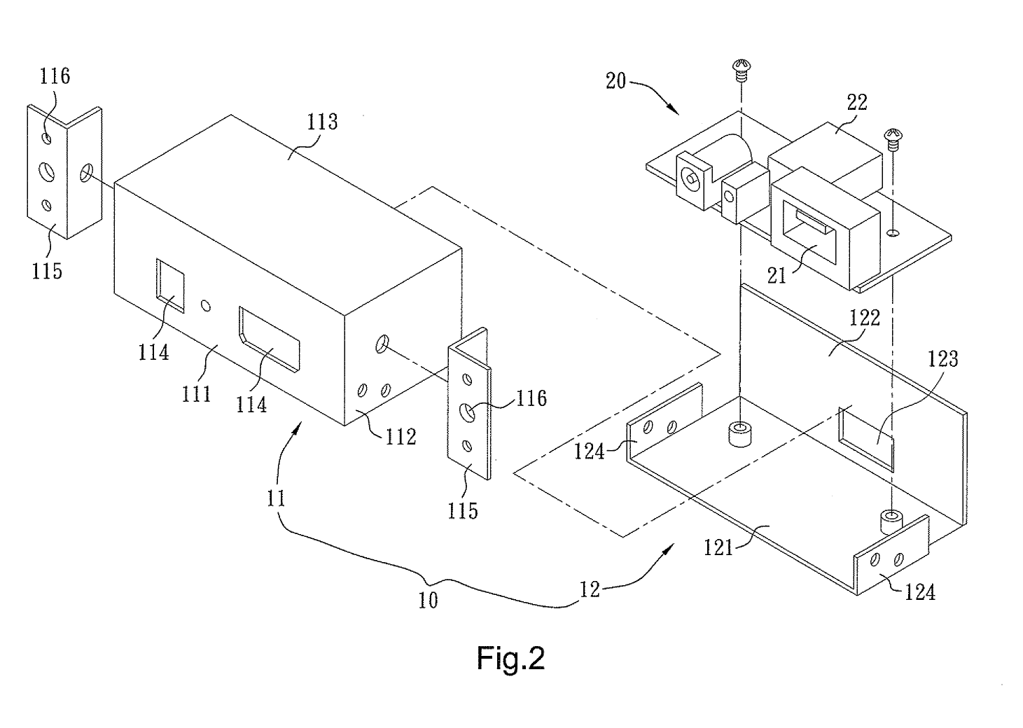

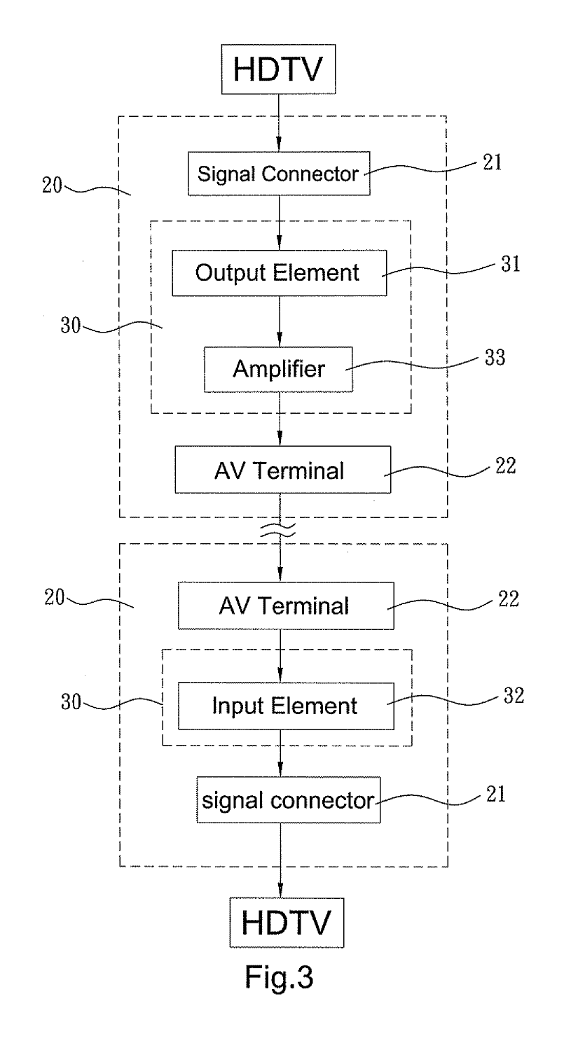

Referring to the drawings and initially to FIGS. 1-3, an AV signal repeater in accordance with the present invention comprises a casing (10) having a receiving space defined therein. The casing includes a cover (11) and a seat (12) attached to each other for defining the receiving space. The cover (11) includes a front panel (111 ), two side panels (112) respectively extending from two opposite sides of the front panel (111) and a top panel (113) connected to the front panel (111) and the two side panels (112). There are multiple openings (114) is defined in the front panel (111). Two wing plates (115) are respectively attached to a corresponding one of the two side panels (112). Each wing plate (115) has at least one hole (116) defined therein. The seat (12) has a lower panel (121) and a rear panel (122) perpendicularly extending from one side of the lower panel (121) opposite to the front panel (111). The rear panel (122) has at least one opening (123) defined therein and the lower panel (121) has two protrusions (124) upward and perpendicularly extending from two opposite side of the lower panel (121).

A printed circuit board (20) is received in the casing and secured on the lower panel (121). A signal connector (21) is electrically mounted on the printed circuit board (20) and partially received in a corresponding one of the multiple openings (114) in the front panel (111). In the preferred embodiment of the present invention, the signal connector (21) is an AV signal connector, such as a high-definition multimedia interface (HDMI) or a universal serial bus (USB). At least one AV terminal (22) is electrically mounted on the printed circuit board (20) and partially received in the opening (123) in the rear panel (122).

At least one signal transmission unit (30) is disposed on the printed circuit board (20) and electrically connected to the AV socket (22). The signal transmission unit (30) includes an output element (31), an input element (32) and an amplifier (33).

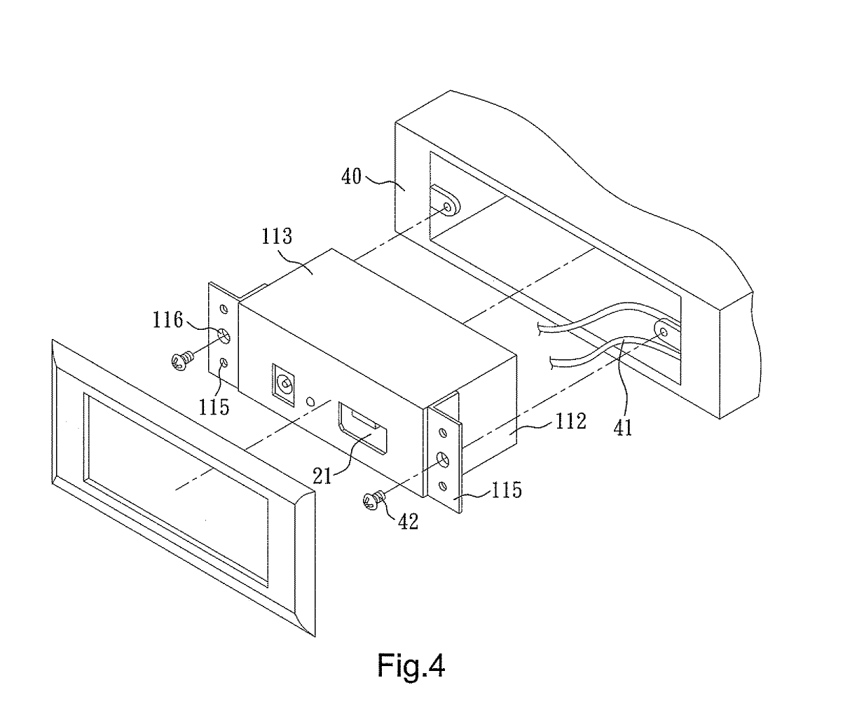

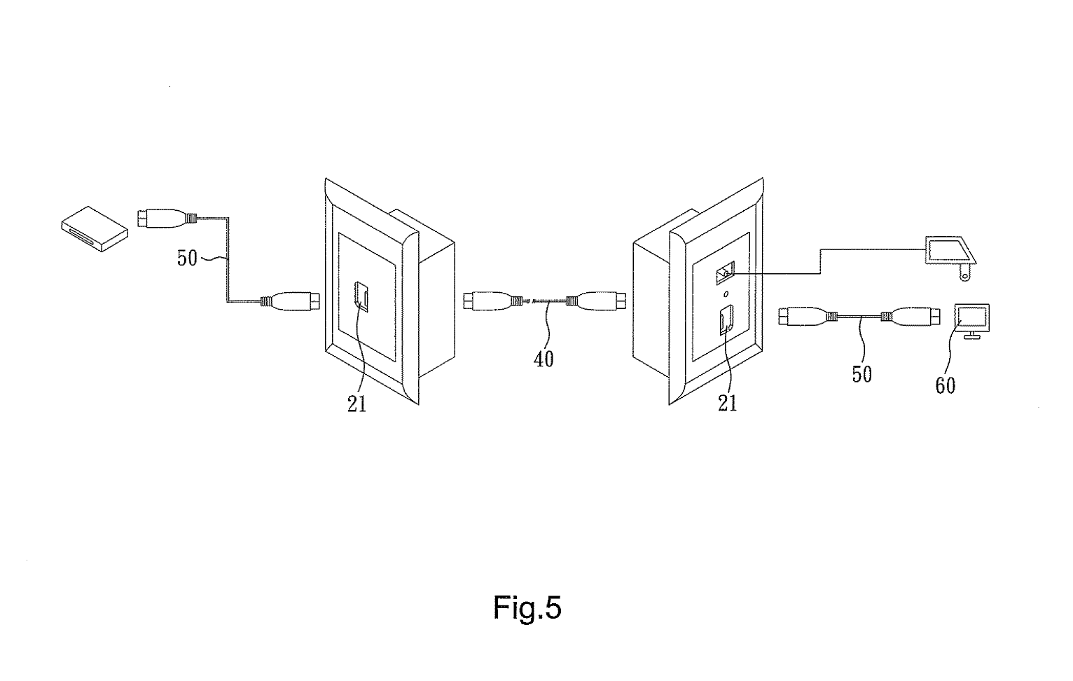

With reference to FIG. 4, the AV signal repeater of the present invention is adapted to be mounted to a distribution box (40) that is previously embedded in a wall. Each hole (116) in the wing plate (115) has a bolt (42) extending therethrough and screwed into the distribution box (40) to hole the AV signal repeater in place. The at least one AV terminal (22) is electrically connected to AV cables (41) in the distribution box (40). A transmission cable (50) is provided to electrically connect the signal connector (21) and a high-definition television (HDTV) (60). As a result, the AV signals of the screen, the monitor and the HDTV (60) can be transmitted to another AV signal repeater in another room, as shown in FIG. 5, via the transmission cable (50), the signal connector (22), the output element (31) and the AV cable (41) that is previously embedded in the wall. As described above, the AV cable (41) is previously embedded in the wall such that the floor and the wall will not be occupied by the AV cable (41) and the AV signals can be shared.

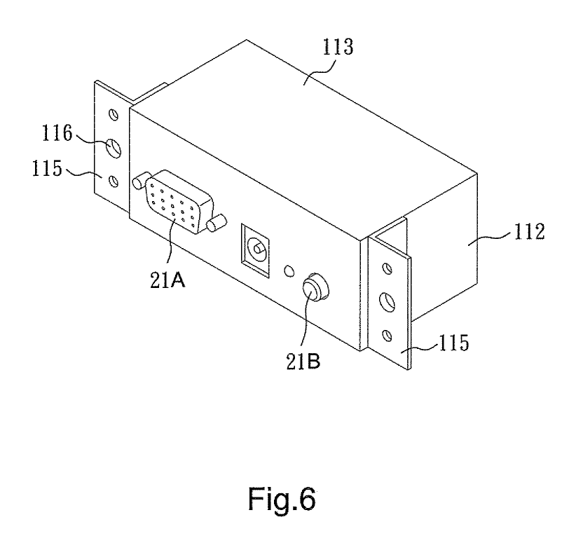

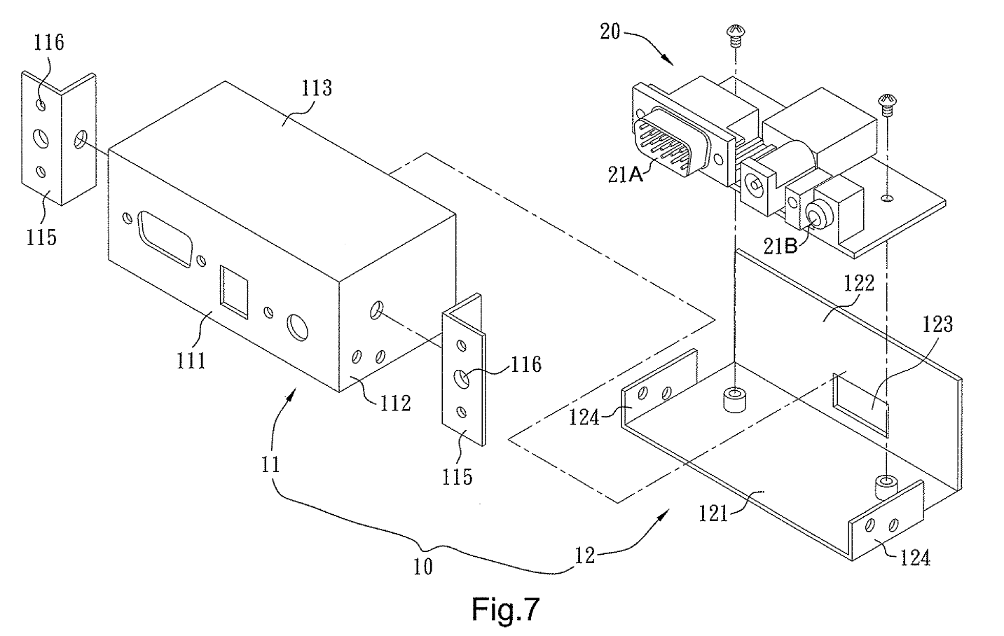

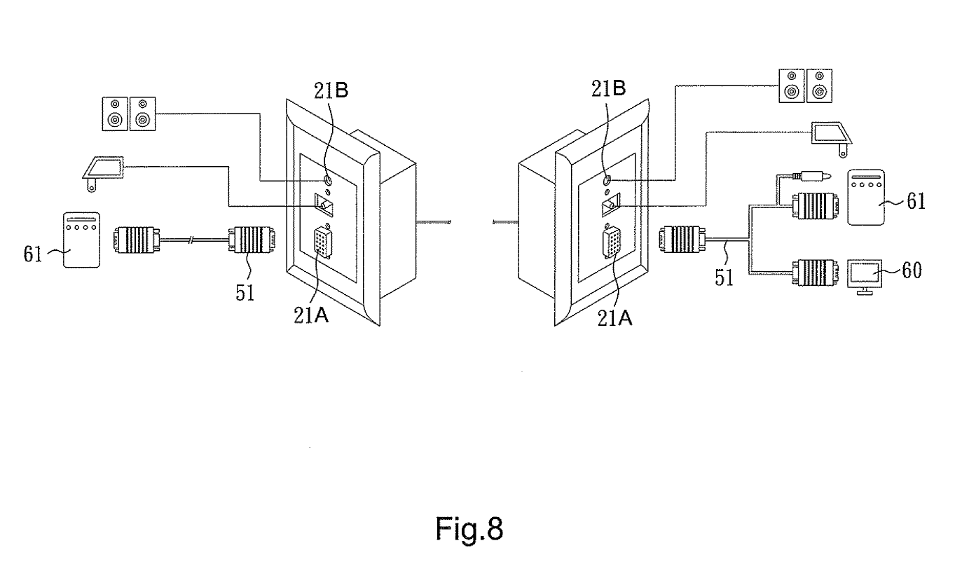

With reference to FIGS. 6 and 7 that show a second embodiment of the AV signal repeater in accordance with the present invention, the PCB (20) has a first and a second signal connectors (21A, 21B) electrically mounted thereon and corresponding to the openings (114) in the front panel (111), wherein the first signal connector (21A) is an AV connector that can be connected to a screen, a monitor, a HDTV (60) or a computer (61), as shown in FIG. 8, and the second signal connector (21B) is an audio connector that can be connected to a speaker. As a result, the AV signals of the screen, the monitor, the HDTV (60) and the computer (61) can be transmitted to another AV signal repeater in another room via the transmission cable (50), the signal connectors (21A, 21B), the output element (31) and the AV cable (41) that is previously embedded in the wall such that the floor and the wall will not be occupied by the AV cable (41) and the AV signals can be shared.

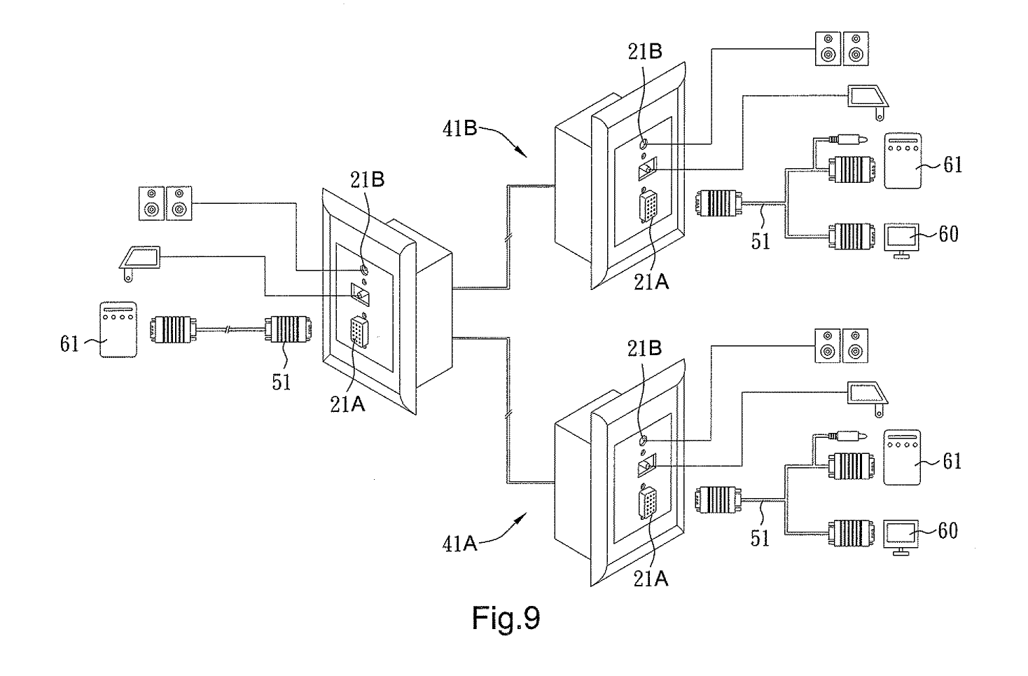

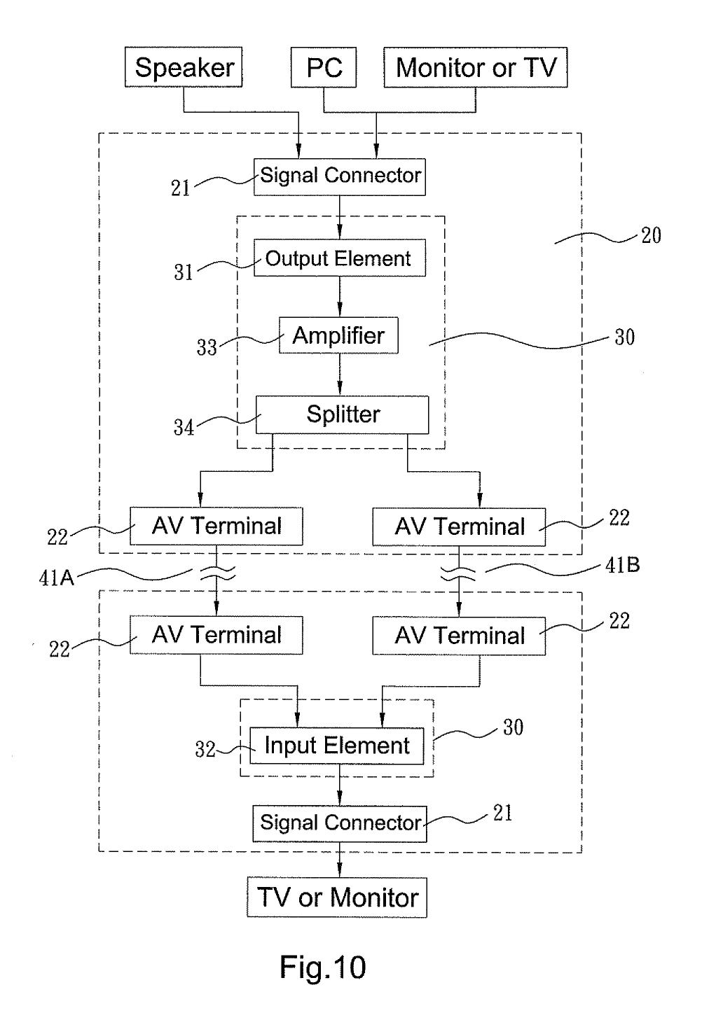

With reference to FIGS. 9 and 10 that show a third embodiment of the AV signal repeater in accordance with the present invention, the PCB (20) has two AV terminals (22) electrically mounted thereon and corresponding to the rear panel (122). In addition, the signal transmission unit (30) includes an output element (31), an amplifier (33) and a splitter (34). The splitter (34) electrically connected to the two AV terminals (22) and the two terminals (22) are respectively electrically connected to two AV cables (41A, 41B). The two AV cables (41A, 41B) are respectively electrically connected to two AV signal repeaters that are disposed in different places. The splitter (34) divides one AV signal into two AV signals that can be transmitted to different place via two AV cables (41A, 41B) that are previously embedded in the wall such that the floor and the wall will not be occupied by the AV cables (41A, 41B) and the AV signals can be shared.

Although the invention has been explained in relation to its preferred embodiment, it is to be understood that many other possible modifications and variations can be made without departing from the spirit and scope of the invention as hereinafter claimed.

What is claimed is:

1. An AV signal repeater comprising:
a casing having a receiving space defined therein;
a printed circuit hoard (PCB) secured in the receiving space in the casing, the PCB including at least one signal connector electrically mounted on a first side of the PCB and at least one terminal electrically mounted on a second side of the PCB; and
at least one signal transmission unit disposed on the PCB, the at least one signal transmission unit electrically connected to the at least one signal connector and the at least one terminal.

2. The AV signal repeater as claimed in claim 1, wherein the at least one signal connector is an AV signal connector.

3. The AV signal repeater as claimed in claim 1, wherein the at least one terminal is an AV terminal.

4. The AV signal repeater as claimed in claim 1, wherein the PCB includes a first signal connector and a second signal connector respectively electrically mounted thereon, the first signal connector being a video signal connector and the second signal connector being an audio signal connector.

5. The AV signal repeater as claimed in claim 1, wherein casing includes a caver and a seat attached to each other to define the receiving space.

6. The AV signal repeater as claimed in claim 5, wherein the cover includes a front panel and two side panels respectively extending from two opposite sides of the front panel and top panel connected to the front panel and the two side panels, and the seat includes a lower panel and a rear panel extending from the lower panel, the lower panel having two protrusions upward extending from two opposite sides of the lower panel.

7. The AV signal repeater as claimed in claim 6, wherein the cover includes two wing plates each laterally attached to a corresponding one of the two side panels of the cover, each wing plate having a hole defined therein.

8. The AV signal repeater as claimed in claim 6, wherein the front panel has multiple openings defined therein for partially receiving the at least one signal connector.

9. The AV signal repeater as claimed in claim 6, wherein the rear panel has at least one opening defined therein for partially receiving the at least one terminal.

10. The AV signal repeater as claimed in claim 1, wherein the signal transmission unit includes an output element and an inlet element.

11. The AV signal repeater as claimed in claim 1, wherein the signal transmission unit includes a splitter.

12. The AV signal repeater as claimed in claim 10, wherein the signal transmission unit includes a splitter.

13. The AV signal repeater as claimed in claim 11, wherein the signal transmission unit includes an amplifier.

14. The AV signal repeater as claimed in claim 12, wherein the signal transmission unit includes an amplifier.
